(19) United States
(12) Patent Application Publication
(10) Pub. No.: US 2010/0250448 A1
(43) Pub. Date: Sep. 30, 2010

(54) LOGISTICS, MAINTENANCE, AND OPERATIONS DATA VISUALIZATION SYSTEM AND METHOD

(76) Inventor: Eric S. Towe, Vandalia, OH (US)

Correspondence Address: DINSMORE & SHOHL LLP, FIFTH THIRD CENTER, ONE SOUTH MAIN STREET, SUITE 1300, DAYTON, OH, 45402-2023, US

(21) Appl. No.: 12/681,859

(22) PCT Filed: Oct. 9, 2008
(86) PCT No.: PCT/US08/79322

§ 371 Date: Apr. 6, 2010

Related U.S. Application Data
(60) Provisional application No. 60/978,589, filed on Oct. 9, 2007.

(51) Int. Cl. G06Q 10/00; G06Q 50/00

(52) U.S. Cl. 705/302; 705/305; 705/348

(57) ABSTRACT

A computer system (10) for logistics, maintenance, and operations data visualization and method thereof are disclosed. The computer system is configured to receive maintenance and repair data from multiple sources on a platform, and uses maintenance codes and their respective narrative descriptions, part numbers, and other maintenance coding information as a basis for finding inaccuracies and inconsistencies in the received data. The system is also configured to correct these mismatches (refining of data) and perform multiple analysis functions of the refined data (most common occurrences, most frequently removed parts, repairs requiring most maintenance labor hours, highest-cost replacements, etc.). In addition, the system is also configured to calculate cost per operating hour/mile/day/etc., tracks removal of warranted components, and contains a predictive capability that becomes more accurate as additional data is acquired and continuously updated (data minding).

The present invention relates generally to computerized support systems and data visualization methods, and in particular to logistics, maintenance, and operations data visualization system and method which may assist a broad range of commercial and military operators in managing fleet systems in a highly reliable and predictive manner.

Condition-Based Maintenance (CBM) is a set of maintenance processes and capabilities derived from real-time assessment of conditions of a platform, such as a weapon system, transport vehicles, hardware, etc., obtained from embedded sensors and/or external test and measurements using portable equipment. Condition-Based Maintenance Plus (CBM+)—expands upon the basic concepts of CBM, encompassing other technologies, processes, and procedures that enable improved maintenance and logistics practices. The major goal of CBM and CBM+ is to perform maintenance only upon evidence of need. However, a number of problems currently exist in attaining this goal, some of which are discussed hereafter.

In the example of military maintenance systems, individual bases do not directly access fleet-wide parts information and may be unaware of specific concurrent parts issues. Such systems impact safety, reliability, and maintainability by delayed human recognition of geographically separated yet related events. In addition, risks identified at one location may not be identified at other locations until an incident has occurred. Existing systems, such as the Contracted Logistics Supply (CLS) system, may inhibit timely collection of valuable metrics. Problems with specific parts and/or processes are discovered slowly, thereby increasing operator risk. Lack of metrics limits opportunity for safety assessments, parts/process improvements, and savings through warranty recovery. Furthermore, Contractor Operated and Maintained Base Supply (COMBS) systems may make price adjustments in deference to warranty situations, but such adjustments are likely only estimates whose accuracy cannot be confirmed by current methods. As such, the customer using such systems receives questionable benefit from warranted parts. Also, the customer has minimal insight into which parts have warranty coverage, for how long, or under what conditions. As used in these examples, the customer may be a government agency, a corporate entity, or any organization having logistics, maintenance, and operations needs.

Limited parts information provided to the customer increases the risk that customer will be charged full price. Improper planning/parts management by the contractor allows warranties to expire while parts sit on the shelves of the customer. Lacking comprehensive and pertinent parts information, the customer has no means of correcting this situation. Moreover, Platform-level Performance-Based Logistics (PBL) systems limit the opportunities for competition and savings. Spare parts are purchased through COMBS without the option of discount from competitors. Furthermore, entering a PBL contract without adequate baseline data increases risk that the arrangement may not be cost effective.

Still further problems include that there is no direct tracking of warranty conditions by the customer. The customer cannot track comprehensive metrics and warranty issues using current methodology, which is to manually scour databases and spreadsheets. The customer cannot accurately assess reliability issues, product improvements, or accomplish best business case analyses without all pertinent information. Lack of metrics renders even limited access to Technical data nearly valueless, and puts an inordinate level of trust in the contractor's complete understanding of the customer operator activities and risks. Current systems also restrict the customer's ability to direct contractor efforts. Combined with insufficient rights to technical data, current system could severely limit long-term support options and increase costs.

It is noted that there is no mechanism in place to obtain and utilize real-time data with such systems. Current widespread methods for collecting data take several days or weeks to obtain parts and operational information. Potentially life-saving decisions are unnecessarily delayed.

Most parts management systems in place today do not track parts information, by either lot number or part number. However, such information is important when identifying and removing potentially flawed or problem parts, and for warranted part identification. Lack of accessing readily such information affects both product and process improvement initiatives. Parts Management and Warranty operations remain predominately a manual task. Warranty activity is effectively non-existent at the operational level. Returns are handled by the parts supplier and typically not coordinated with the user. Accordingly, lack of automation leads to inaccuracy, excessive manpower, and increased cost. Parts Management and Warranty operations currently are also organizationally segregated. Various COMBS Operators do not coordinate activities (no service-wide standardization). Bases typically follow their own local procedures. Lack of standardization increases cost as each activity is a one-of-a-kind operation. Parts Management and Warranty operations are often service specific. Each service utilizes individual and distinct nomenclature, procedures, and equipment. Lack of a shared multi-service standard adds to overall complexity and increases the customer costs.

Moreover, differences of opinion between end users of the customer and Original Equipment Managers (OEM) have demonstrated how difficult it is to even reach a consensus as to what constitutes a critical system. Maintenance personnel have a tendency to emphasize failures that require excessive repair time. Operators have a tendency to emphasize failures that impact mission completion. Requirements personnel must address and prioritize issues that are raised both above and below their particular position in the decision chain. Program office (platform-specific) personnel must address all of these issues and correlate them with their own logistics, engineering, and acquisition strategies. Whether or not a problem is addressed is also a function of the platform budget. Less than adequate manning and a heavy workload restrict freedom to randomly explore unreported issues. Unofficial “until it breaks, don't fix it” methods of operation can be common. Time is simply not available to accomplish meaningful analysis of all relevant platform data.

It is against the above described background that the present invention provides computer implemented processes, which through use of information technology products and services, provides, to note a few, the following capabilities: unbeatable analysis of maintenance activities, parts usage, labor hours, and any other data the customer desires; analysis that not only encompasses an entire platform's history, but analysis that is also continuously updated by the addition of new data (data minding); mathematical probability equations are applied to provide correlated, accurate, predictive calculations for parts usage, parts life, preventive maintenance planning, and budget forecasting; assembles parts usage information, parts cost information, labor hours, cost of labor, and warranty recovery projections to provide an accurate, updated Operating Cost for the platform; provides for a separate calculation of projected savings from warranty recoveries; ranking of priorities and high drivers both platform-wide and within specific systems/modules; when used with multiple platforms, provides priority rankings per platform as described above, but also compiles priority rankings from all platforms combined for use by high-level management personnel; provides automatic alerts based on user-defined thresholds to prevent potentially significant issues from going unnoticed until a mishap has occurred; tracks and identifies trends (negative, positive, or neutral) associated with continuous improvement initiatives; and utilizes trends, usage, and ranking information to suggest continuous improvement initiatives.

The present invention produces a highly refined analytic result, allowing customers to glean valuable information from vast data storage repositories. Some of the noted benefits of the present invention, include, and not limited thereto, facilitating operators and program personnel to: observe deficiencies in real-time at other bases/maintenance locations; enhance safety through early trend recognition; increase reliability by quickly pinpointing problem areas requiring modification; track the effectiveness and quality of Performance Based Logistics processes; manage risk based on projected product failures; understand which factors affect the failure rate of a particular component; and provide more realistic operational limits and better maintenance predictability.

In addition, the present invention facilitates reduction in program costs through metric analysis, warranty recovery, and decreased cost per operating hour. COMBS/parts/supply inventories can be proactively controlled, resulting in a higher return on investment for the client.

The present invention also helps to prevent warranty expirations due to overstock, and predict parts ordering based on actual inventory data. The precise data results provided by the present invention will permit increased accuracy in budget forecasts for planned expenditures, and can be used to track vendor performance to identify problem areas as well as success stories.

The present invention should help increased productivity through alternate use of personnel operating legacy systems. The present invention, by providing near real-time data, can provide the necessary background information when deficiencies are discovered. Personnel previously used to mine background data are now available for other tasking. Near real-time data availability of the present invention will assist in: resolving quality issues quickly; simplifying engineering and production control; and eliminating defective components earlier in the acquisition process.

In one embodiment a computer-readable medium, tangibly embodied, including a logistics, maintenance, and operations data visualization (LMO) tool is disclosed. The computer-readable medium comprising instructions for receiving maintenance and repair data from multiple sources; using maintenance codes and their respective narrative descriptions, part numbers, and other maintenance coding information provided in the maintenance and repair data as a basis for finding inaccuracies and inconsistencies in the received maintenance and repair data; correcting found inaccuracies and inconsistencies in the received maintenance and repair data to provide refined data; performing multiple analysis functions of the refined data to determine at least a base statistics and a reliability forecast for each component provided in the received maintenance and repair data; generating a report for viewing each component and the associated base statistics and reliability forecast; and displaying the report on an output device.

In another embodiment of the computer-readable medium, the received maintenance and repair data includes component types categorizing parts for a specific platform.

In another embodiment of the computer-readable medium, the base statistics provided in the generated report includes information relating to part information and activity information.

In another embodiment of the computer-readable medium, the reliability forecast provided in the generated report includes information relating to part information and desired target reliability rate fields.

In another embodiment of the computer-readable medium, the part information includes at least one of a part maintenance code, a part category, a part name, and a maintenance manual reference, and the activity information includes at least one of maintenance actions, unscheduled maintenance actions, parts removed, average maintenance hours, maintenance hours, parts under warranty, and percentage of parts under warranty.

In another embodiment of the computer-readable medium, the part information includes at least one of a part maintenance code, a part category, a part name, a maintenance manual reference, and a part unit cost, and the desired target reliability rate fields correlates operating limits with each level of desired reliability, along with the number of such parts needed on hand in supply per year and the associated cost in order to meet each level of desired reliability for a given operating limits.

In another embodiment, the computer-readable medium further includes instructions for enabling a user to populate the reliability forecast with customized data.

In another embodiment of the computer-readable medium, the specific platform include at least one of an airplane, a weapon system, and military hardware.

In another embodiment, the computer-readable medium further includes instructions for sending notification to responsible ones of the multiple sources when a component in the report is indicated as removed and under warranty for replacement.

In another embodiment, the computer-readable medium further includes instructions for enabling a user to select in the report a rank view, selected maintenance code view, and a source records view.

In yet another embodiment, a method for providing a logistics, maintenance, and operations data visualization (LMO) tool, to a user is disclosed. The method comprises receiving maintenance and repair data from multiple sources on a platform; using maintenance codes and their respective narrative descriptions, part numbers, and other maintenance coding information provided in the maintenance and repair data as a basis for finding inaccuracies and inconsistencies in the received maintenance and repair data; correcting found inaccuracies and inconsistencies in the received maintenance and repair data to provide refined data; performing multiple analysis functions of the refined data to determine at least a base statistics and a reliability forecast for each component provided in the received maintenance and repair data;

generating a report for viewing each component and the associated base statistics and reliability forecast; and displaying the report on an output device of the platform.

In still another embodiment a computer system is disclosed which comprises an output device; an input device; a central processing unit in communication with the input device and output device; and the computer readable medium as in any one of the above mentioned paragraphs, wherein the central processing unit executes the instructions to provide the LMO tool.

Other objects, features and advantages will occur to those skilled in the art from the following detailed description of various embodiments and the accompanying drawings.

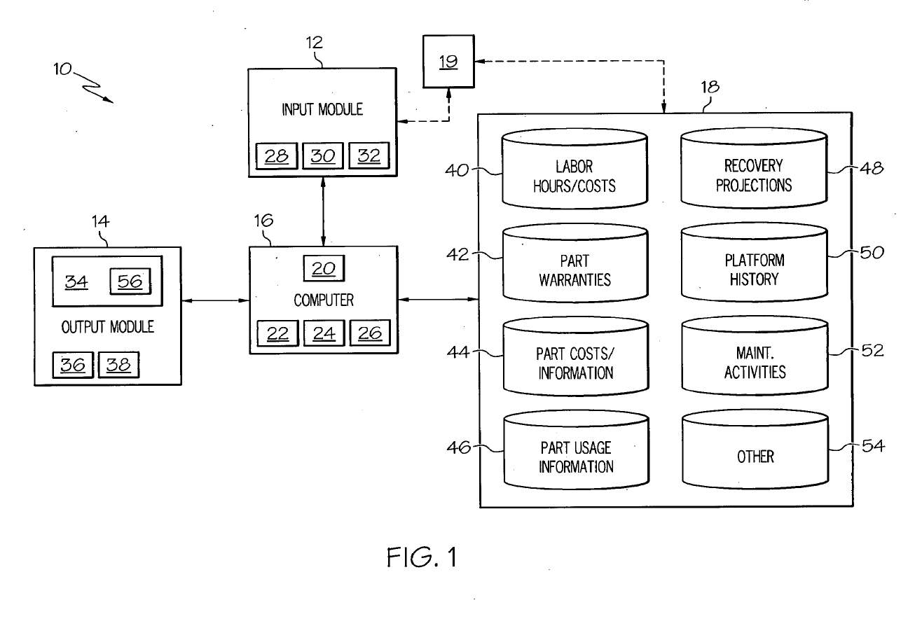

FIG. 1 discloses a powerful Logistics, Maintenance, and Operations Analysis and Visualization (LMO) system according to an embodiment of the present invention.

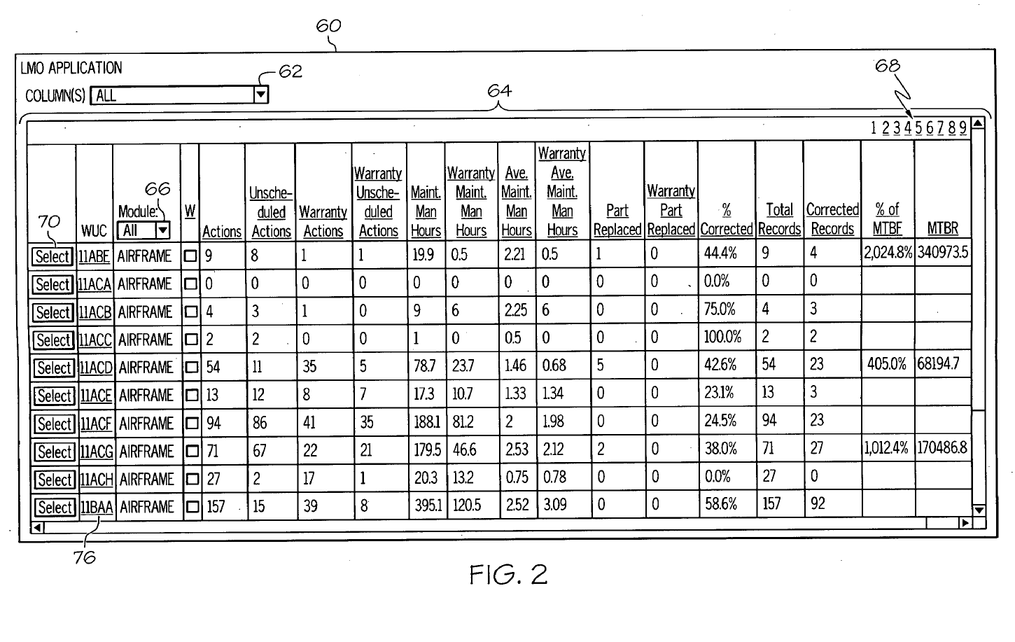

FIGS. 2-4 are depictions of information according to embodiments of the present invention provided by the system of FIG. 1.

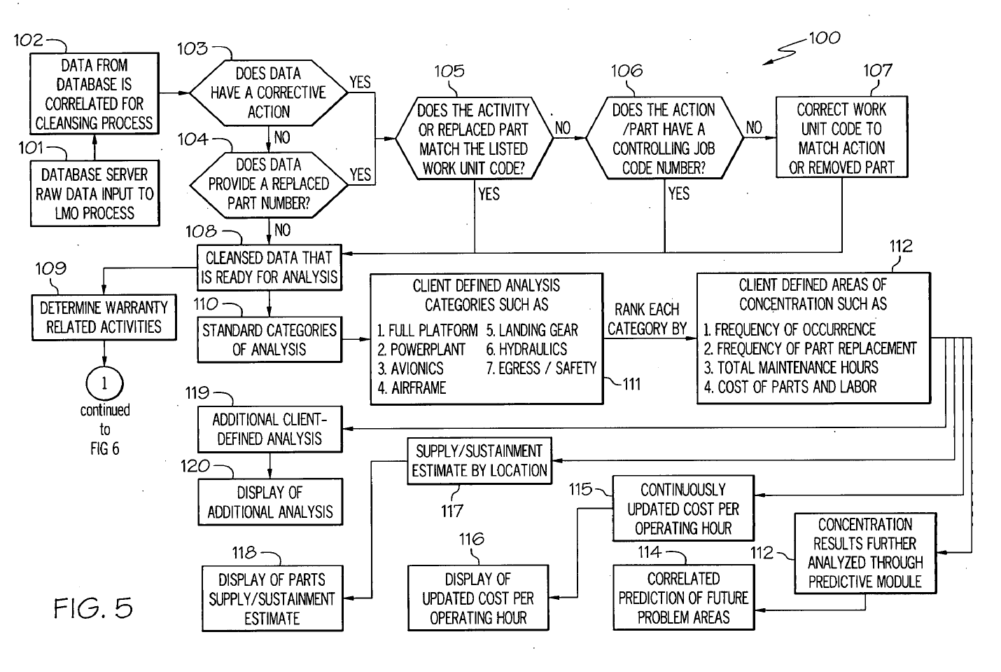

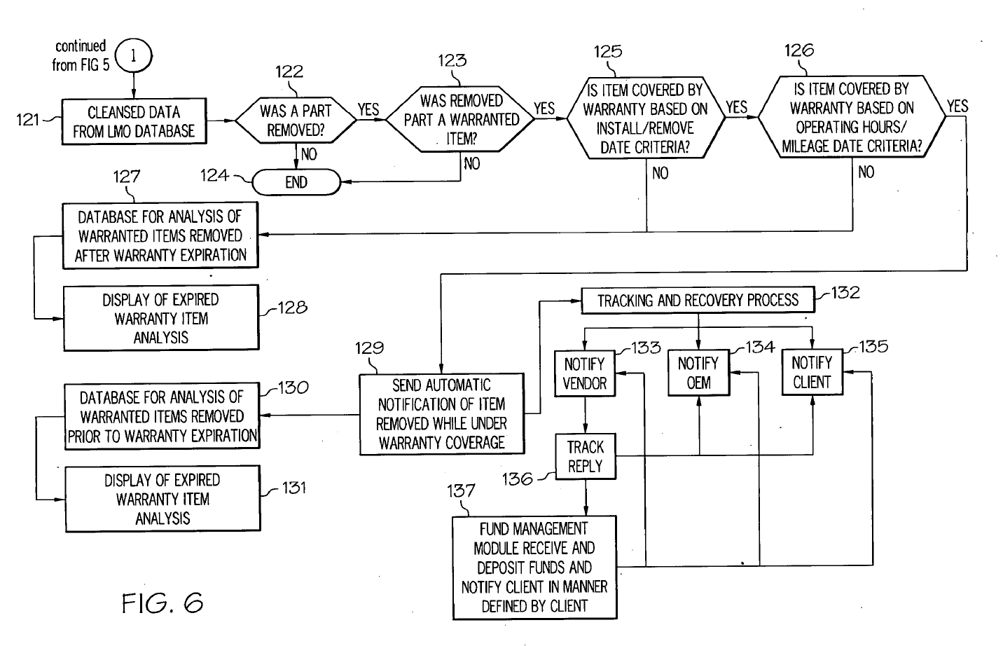

FIGS. 5 and 6 are flowcharts illustrating the processing of an embodiment of the present invention, such as on the system of FIG. 1.

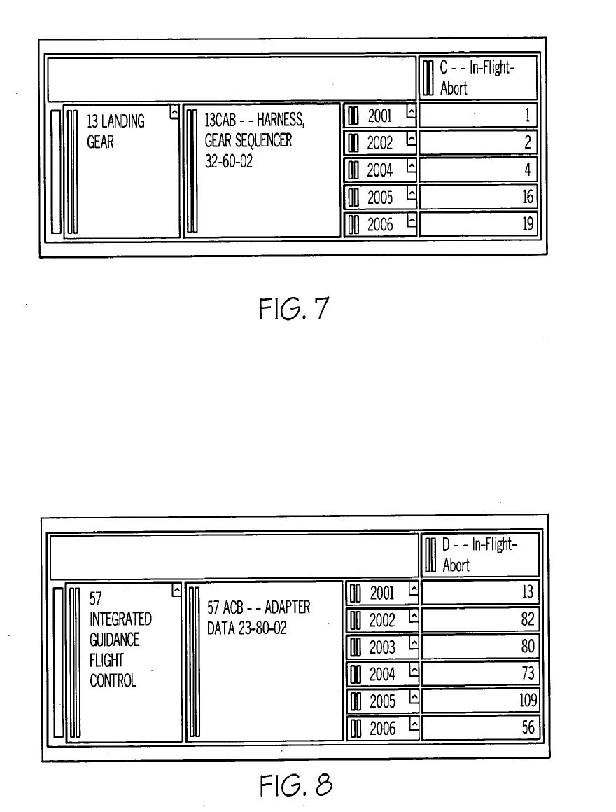

FIGS. 7-12 are depictions of information according to embodiments of the present invention provided by the system of FIG. 1.

Before the present system and methods are described, it is to be understood that this invention is not limited to particular hardware or software described, as such may, of course, vary. It is also to be understood that the terminology used herein is for the purpose of describing particular embodiments only, and is not intended to be limiting.

FIG. 1 discloses a Logistics, Maintenance, and Operations Analysis and Visualization (LMO) system, providing visualization tools, functionality, prognostics, and analysis useful in helping a user to accomplish the sustainment and logistics goals desired under government and commercial predictive maintenance programs. Generally, the present invention supplies users with the independent analysis required to achieve meaningful, affordable, and responsible oversight. In addition to data analysis, the system 10 also provides full-platform data minding, which entails continual analysis updates as new data is added to the system 10.

As shown, system 10 may include an input module 12, an output module 14, and a computing platform 16. Computing platform 16 may include or may be otherwise operatively coupled to a database 18. In one embodiment, the database 18 may a database served by a database server 19 with data provided to the computing platform 16 via the database service 19, such as through a network interface 32 of the input module 12. In another embodiment, the database 18 may be records stored in a memory 20 accessible by the computing platform 16. Database 18 may include more than one database or another type of electronic repository. It is also contemplated that system 10 may obtain information from sources other than database 18, which may be either public or private. Computing platform 16 may include the necessary functionality and computing capabilities to implement the functionalities of the LMO system through input module 12, provide output to output module 14, and access, read, and write to database 18.

The results of the LMO system 10 may be provided as output from computing platform 16 to output module 14 for printed display, viewing, and/or further communication to other system devices. Such output may include, for example, reports, statistics, forecast, records, or information obtained from the LMO system 10 for the user's reference. Output from computing platform 16 can also be provided to database 18, which may be utilized as a storage device for LMO information from customers or providers.

In one embodiment, computing platform 16, and input and output module 12, 14 may be implemented as a conventional personal computer (PC), and in another embodiment, as a mainframe computer configured to perform the various functions and operations according to the present invention. In another embodiment, computing platform 16 may be implemented, for example, by a general purpose computer selectively activated or configured by a computer program stored in memory of the computer, or may be a specially constructed computing platform for carrying out the features and operations of LMO system 10. Computing platform 16 may also be implemented or provided with a wide variety of components or subsystems including, for example, one or more of the following: a processor 22, a co-processor 24, a register 26, and/or other data processing devices and subsystems. Computing platform 16 may also communicate or transfer the functionality of the LMO system to input module 12 and/or from output module 14 through the use of direct connections or other communication links, as illustrated in FIG. 1. In an exemplary embodiment, a firewall may prevent access to the computer platform 16 by unauthorized outside entities. It is further contemplated that computing platform 16 may require user authentication, such as password verification, in order to prevent unauthorized users from gaining access to LMO information from a particular customer or provider.

Input module 12 may include a wide variety of devices to receive and/or provide the data as input to computing platform 16. As illustrated in FIG. 1, input module 12 may include an input device 28, a storage device 30, and/or the network interface 32. Input device 28 may include a keyboard, mouse, touch screen, disk drive, video camera, magnetic card reader, or any other suitable input device for providing data to computing platform 16.

Memory 20 may be implemented with various forms of memory or storage devices, such as hard disc drives, read-only memory (ROM) devices, and random access memory (RAM) devices. Storage device 30 may include a memory tape or disk drive for reading and providing data as input to computing platform 16. Network interface 32 may receive data over a network (such as a LAN, WAN, intranet or the Internet) and provide the same data as input to computing platform 16. For example, network interface 32 may be connected to a public or private database for the purpose of receiving information about users, such as customers or machinery providers, from computing platform 16.

Output module 14 may include a display 34, a printer device 36, and/or a network interface 38 for receiving the results provided as output from computing platform 16. As indicated above, the output from computing platform 16 may include one or more reports, statistics, forecast, records, and/or information obtained from the LMO system 10 for the user's reference. The output from computing platform 16 may be displayed or viewed through display 34 (such as a CRT or LCD) and printer device 36.

Network interface 38 may also facilitate the communication of the output from computing platform 16 over a network (such as a LAN, WAN, intranet or the Internet) to remote locations for further analysis, viewing or storing.

It is further contemplated that communication between computing platform 16, input and output modules 12, 14, and database 18 as well as server 19, if so configured, can be achieved through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. By using dedicated communication links or a shared network architecture, computing platform 16 may be located in the same location or at a location geographically remote from input module 12, output module 14, and/or database 18.

Data provided from various sources (i.e. various other databases and/or legacy systems) may be stored in associated database files or records in the database 18. For example, database 18 may include information such as: labor hour and cost data 40 associated with each part of a platform and provided from a maintenance/repair organization; part warranties data 42 provided from a parts supplier; part costs and description information 44 provided from a purchasing agency; part usage information 46 from an operational unit; recovery projections data 48 previous computed by the LMO system 10; platform history data 50 provided from an in-service inspection organization; and maintenance activities data 52 provided from the same and/or other maintenance/repair organizations. Database 18 may further include other information 54 assigned or otherwise programmed by a user. In other embodiments, the above mentioned data and information may be furnished by a particular customer, parts provider, or the user. It is to be appreciated that the data made available to the user through the system 10 is typically data that is not utilized due to data inaccuracies, data inconsistencies, and volume that overwhelms current methodologies. As such, the system 10 is capable of interfacing with data from any format, preventing a complete overhaul of established client data collection and storage processes. Customers are thus are able to retain legacy data systems while at the same time utilizing the latest in data refining and analysis capabilities provided by the system 10.

As illustrated by FIGS. 2-4, the system 10 provides various types of displays to help the user visualize the information provided in the data gathered from one or more sources. For example, information from database 18 may be accessed and viewed via a graphical user interface (GUI) 56 provide on the display 34 of the output module. The GUI 56 displays the information stored within database 18 in a number of reports and tables.

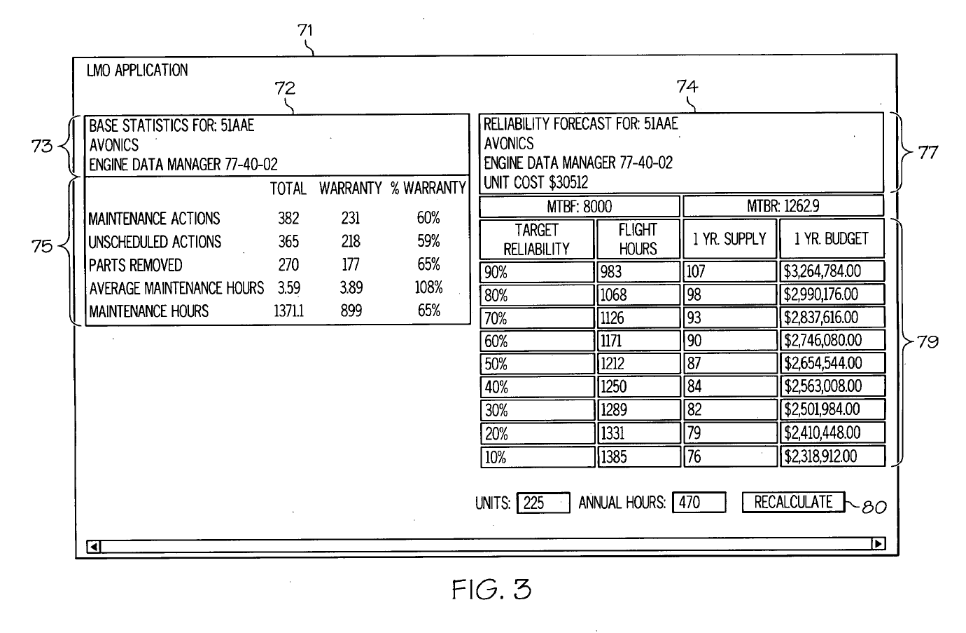

For example, FIG. 2 is a ranking report 60 provided by the LMO system 10 in GUI 56. The ranking report 60 provides a tab control 62 used to select which information columns 64 to display as well as a drop down category selection box 66 to select which type of part categories of a platform to display in GUI 56. For example, in the illustrated embodiment, the categories provided by the LMO system 10 for the particular weapon system platform (i.e., an air plane) are: All, Airframe, Avionics, CAD/PAD (i.e., Cartridge Actuated Device/Propellant Actuated Device), Electrical, Emergency, Fire storage, Fuel, Hydraulic, Landing gear, Oxygen, and Powerplant. A page selection tab control 68 is also provided for the user to select to quick view a particular page in the ranking report 60 as well as a row selection control 70 which when selected opens a Row Selection Analysis report 71 shown by FIG. 3.

The Row Selection Analysis report 71 provides a base statistics report box 72 and a reliability forecast report box 74. The base statistics report box 72 provides part information 73, such as for example, the part maintenance code, module (i.e., part category), part name, and a maintenance manual reference, and activity information 75 such as, for example, maintenance actions, unscheduled maintenance actions, parts removed, average maintenance hours, and maintenance hours, and warranty and warranty percentage for each item in the displayed activity information. The reliability forecast report box 74 provides reliability forecast information 77 such as for example, the part information 73 as well as unit cost of the part, manufacturer predicted life of the part, and a field failure rate based on the actual life of the part. The reliability forecast report box 74 also provided target desired reliability rate fields 79 which correlates operating limits (e.g., Flight hours) with each level of desired reliability, along with the number of such parts needed on hand in supply per year and the associated cost in order to meet each level of desired reliability for the given operating limits. The user is able to set custom numbers for platforms and operating levels and recalculate to see the effect on supply numbers and cost via button 80. Such is useful when doing forecasting based on what-if-scenarios.

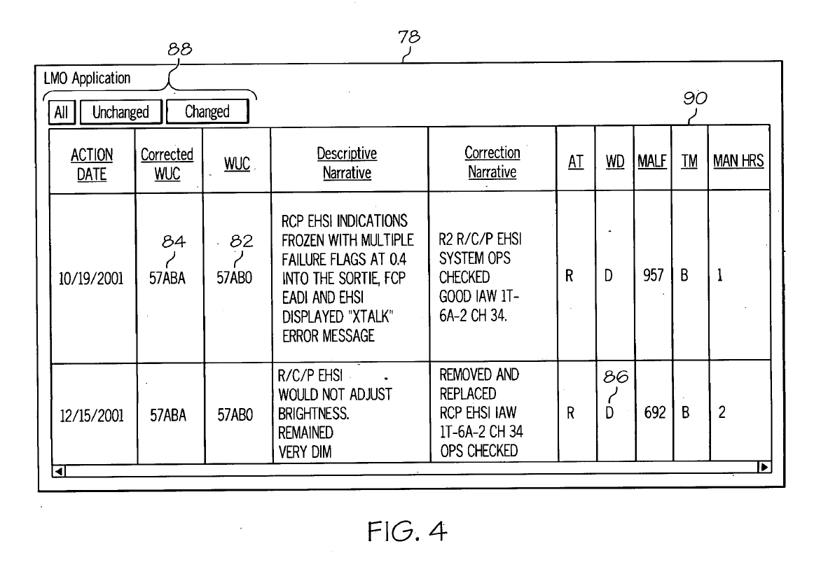

Turning back to FIG. 2, the ranking report 60 also permits the user to select on a displayed maintenance code (WUC) 76 to view a WUC Select Analysis report 78 as shown by FIG. 4. The WUC Select Analysis report 78 displays the originally recorded, unaltered maintenance code 82 as well as the newly assigned maintenance code as determined by the processes of the LMO system 10, which is discussed hereafter in a later section. From this report 78, the user also has the able to select in record fields 86 to view each of the source records complied to generate the reports for each part. The user may filter these record fields 86 by using record filtering controls 88, which provide for example, filtering of the records to all, only the unchanged records, or only the changed records. Lastly, as with the ranking report 60, the records may be sorted by a particular column by selecting an associated column header 90. It is to be appreciated that system 10 may develop and provide tailored reports and/or tailored scenarios to users who have particular platform, equipment or logistics needs. System 10 may present the tailored part information via GUI 56.

Although the disclosed implementation may include a particular network configuration, embodiments of the present disclosure may be implemented in a variety of data communication network environments using software, hardware, or a combination of hardware and software to provide the processing functions. Those skilled in the art will appreciate that all or part of systems and methods consistent with the present disclosure may be stored on or read from other computer-readable media. System 10 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) or random-access memory (RAM). Such computer-readable media may be embodied by one or more components of system 10, such as, for example, computing platform 16, database 18, memory 20, processor 22, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The reports, statistics, forecast, records, or parts information obtained from the LMO system 10 for the user's reference may include paper documents, computer files, electronic documents, Internet-based documents, and any other suitable media for documentation. The electronic documents may be provided to members of the target population or customers via various modes of transmission, such as email. Internet-based documents may include word processor type files and/or web pages, which may include the LMO-related information, statistics, forecasts, and/or reports. Administration of such documents may include notifying members in any suitable way of the availability and/or accessibility of such documents, including updated to existing content, and may provide an Internet address for accessing the documents. Implementation of the disclosed system may be, to some extent, undertaken by hand. For example, the determination of which information will be administered to individual users of the target population and/or the assembly of reports may be handled by one or more persons, e.g., representatives, managers or administrators of the machinery providing entity. It is contemplated, however, that either a manual, semi-computerized, or fully computerized implementation may be utilized.

FIGS. 5 and 6 illustrate a flowchart depicting an exemplary process 100 that utilizes the LMO system 10 to process data from the database 18. Since once the functions of the invention are known to one skilled in the art, a software engineer is fully capable of implementing such functions on the necessary computer system(s), such as system 10, and as such no description of the programming language is provided. Generally, the central processing unit 22 of the platform 16 is in communication with the database 18 and the input and output 12 and 14 and is configured perform the steps of the process 100 described hereafter.

As shown by FIG. 5, the basic processes of the present invention is disclosed. In step 101, data is either pushed or pulled from an outside source, and/or disparate sources to database 18. The source of the data is not of a major concern as the system 10 is database agnostic with regards to the data input function. Data is received either in real-time or at user-defined intervals. In step 102, the data received from the source and/or disparate sources is correlated for comparison purposes. An example would be Navy and Air Force data reflecting the same platform where each service records slightly different information. This function ensures cleansed data reflects similar information for analysis.

In step 103, maintenance data is checked. In particular, the system 10 looks at the each data entry and determines whether an entry contains a narrative of the corrective action performed. This is a yes/no function. If there is no corrective action narrative, then in step 104 the system checks each entry to determine whether a part number is present representing a part removed as part of the recorded maintenance activity. If there is no corrective action narrative and no removed part number, then data is placed in the ready-for-analysis repository, such as memory 20, an the process 100 proceeds or skips to step 108 which discussed later hereafter.

Returning to step 103 and 104, if there is a corrective action narrative or a part number is present representing the maintenance action taken, then in step 105 the data is compared to the description of the work unit code assigned to that particular maintenance action. If a match is present in step 105, then data is placed in the ready-for-analysis repository and skips to step 108. If no match in step 105, then in step 106 data is checked for a controlling job code number. Repairs accomplished incidental to another malfunction are grouped under the initial work unit code. If yes in step 106, then the data is placed in the ready-for-analysis repository and the process skips to step 108. If no in step 106, then in step 107 a correction is made to the work unit code to reflect the actual maintenance activity that occurred. Data is then placed in the ready-for-analysis repository, and then the process 100 proceeds to step 108.

In step 108, cleansed data ready for analysis now populates the ready-for-analysis repository. At this point in the process 100, the inputted data has been corrected to permit all follow-on analysis to be accurate and meaningful. In step 109, the cleansed data is mirrored to the warranty module to determine the need for recovery activity. In step 110, the cleansed data is separated into standard analysis categories for display, such as provided in the ranking report 60 (FIG. 2), which show the categories for the full-platform and all major component areas. In step 111, the user may manipulate the GUI 56 by the provided features to display client-defined analysis categories. Display of categories and respective areas of concentration are where the visualization aspect of LMO system 10 are most apparent.

In step 112, within each category are rankings based on specific areas of concentration. These areas, once again, are client-defined but suggested categories include for example, the base statistics report 72 (FIG. 3) in one embodiment, and in other embodiment similar reports providing various aspects of frequency, labor hours expended, cost of parts, cost of labor, etc. Concentration results are routed through the predictive module in step 113. In this module, results are run through statistical modeling and then correlated into a predictive ranking to anticipate problem areas that have perhaps not yet been identified. The reliability forecast report 74 (FIG. 3) is one such example, wherein in step 114, display of such predictive results is provided via GUI 56. In step 115, cost per operating hour in the database entry is continuously updated and refined within this module based on parts usage, labor hours/cost, operating hours, fuel/oil consumption, etc., wherein in step 116, display of such cost per operating hour is then provided via GUI 56. In step 117, the system 10 calculates parts utilization based on number of platforms and operating location and in step 118, displays the calculated parts requirement by operating location via GUI 56. Lastly, in step 119, additional client-defined analysis/calculations of cleansed data may be provided, wherein the results of such additional analysis/calculation are display via GUI 56 in step 120. Details of the warranty data handling of the process 100 is discussed hereafter with reference to FIG. 6.

As shown by FIG. 6, for the warranty determination process aspect of the present invention, in step 121 data is feed from cleansed data repository provided in step 108. The warranty determination process does not require cleansing in the same manner as the other functions of the LMO system 10. Data for warranty determination is retrieved from the LMO system 10 mainly for consistency and uniformity. In step 122, this is a simple yes/no function. If a part was not removed, then there is not a part for which a warranty recovery must be processed and the process is ended in step 124. If yes, then the process proceeds to step 123 of the warranty process. In step 123, if a part was removed, then either the part number or the work unit code is compared to a listing of parts which are covered under some sort of warranty, conditions of which are stored within the warranty process module. If the part is not warranted the process is ended (step 124). If the part is on the warranted item list, then the process moves on to step 125.

Step 124 is the end step for items which a determination has been made that no warranty coverage exists in either steps 122 or 123. No further action is applied to these items. In step 125, if the warranted item has a warranty based on days, months, or years, then the install and remove dates are examined to determine if the item has been removed within the period of coverage. If no, the data is sent for analysis of items whose warranty has expired in step 127. If yes, then data proceeds to step 126. In step 126, despite meeting date criteria, a warranted item may have exceeded operating hour parameters if such parameters have been defined. If data in step 126 has exceeded operating time parameters, then the data is sent for analysis of items whose warranty has expired (step 127). If data in step 126 is within prescribed operating hour limitations, or no operating hour limitations apply, then data is routed to the automated notification process module (step 129).

Step 127 is the analysis performed on data from items whose failure occurred after warranty expiration. Provides insight into quality and reliability of parts. In step 128, a display of the analysis performed in step 127 is provided via GUI 56. In step 129, data reflecting failure of items actively covered by warranty is sent for additional analysis in step 130. Notifications are generated and sent to step 132 for proper routing to client-identified recipients. In step 130, a data repository is provided, such as in database 18 or memory 20, in which the additional analysis is accomplished in order to identify trends, poor performing components, and other user-defined quality/continuous improvement criteria. In step 131, a display of the analysis performed in step 130 is provided via GUI 56.

Step 132 is the beginning of the tracking and recovery process. Failed items covered by a warranty are identified, a recovery notification is generated, notifications are assigned to addressees, and notifications are sent (by e-mail or other user-defined notification method). In step 133, notification of the vendor occurs in which the vendor is notified, for example, of item failure and request for warranty reimbursement or explanation of warranty denial. In step 134, notification of OEM occurs in which the platform manufacturer is advised, for example, that a warranted item has failed and that a warranty recovery request has been generated and sent to the responsible vendor. In step 135, notification of Client occurs in which the platform operator/client is advised, for example, that a warranted item has failed and that a warranty recovery request has been generated and sent to the responsible vendor.

In step 136, the vendor reply is routed to the OEM in step 134 and to Client in step 135. Replies additionally are routed to the Funds Management Module in step 137. For example, in step 137 payments are received and deposited in a client-defined manner. Receipt of payment and deposit notifications are also sent to the vendor in step 133, the OEM in step 134, and Client in step 135.

A case study of the implemented processes of the present invention is provided hereafter.

### Case Study Introduction

The following terminology is used hereafter. “Data minding” is the concept of data mining is familiar, but the system 10 provides data minding. The analysis provided by the system 10 is not a one-shot prospect. The data is continuously updated and re-analyzed to provide current analysis of trends, issues, and non-issues regarding the overall health of the platform/project.

“Mismatches” refers to the inconsistencies that occur frequently in large data collection activities. The LMO system 10 reads the data and arranges it properly so that misidentified information is no longer lost but actually made a part of the comprehensive past, present, and predictive analysis capabilities of the system. “Jewels” are previously, mismatched data that was lost to analysis. Some mismatches are insignificant, but some can be the difference between life and death and/or extreme platform degradation or loss.

The following case study was conducted using maintenance data concerning the T-6A Joint Primary Air Training System (JPATS) turboprop aircraft from Raytheon, which is replacing the U.S. Air Force's (USAF) T-37 and the U.S. Navy's (USN) T-34C aircrafts. For this case study, all USAF maintenance data for the T-6A aircraft from 2000 through 131 Mar. 2006 were provided by JPTAS personnel. The inventors immediately set about converting the text files to database information and commenced analysis to find information previously unknown to JPATS personnel. While conducting this analysis, LMO was specifically requested to provide a special analysis of the Landing Gear System (LGS) information as JPTAS logistics personnel had previously been conducting manual data analysis of the system associated with recent gear-up landing. The jewels provided by the LMO 10 on the inputted data are discussed hereafter with reference made also to FIGS. 7-12, which are results of the analysis provided by the system on GUI 56.

### US Air Force (USAF) Data Analysis

The first analysis looked at all Landing Gear Sequencer Harness in the data having In-flight Aborts. As shown by FIG. 7, the results show a noticeable increase in activity during 2005 and 2006 over previous years was indicated in the data. Such an indication demonstrates a negative recent development, such as in a new lot of parts, whose impact may require intervention. The second analysis looked at all Integrated Guidance Flight Control Data Adapters having no in-flight abort which the results are shown by FIG. 8. Based on the results provided, additional investigation is indicated in order to determined the decrease in the Integrated Guidance Flight Control Data Adapters having no in-flight abort during 2006 as compared to all of 2005. For example, as the T-6A by 2005 was in full rate production, the increase in activity cannot be explained by the addition of new aircraft to the fleet, which is normally one reasonable assumption to the differences indicated in the data from the years prior to 2005.

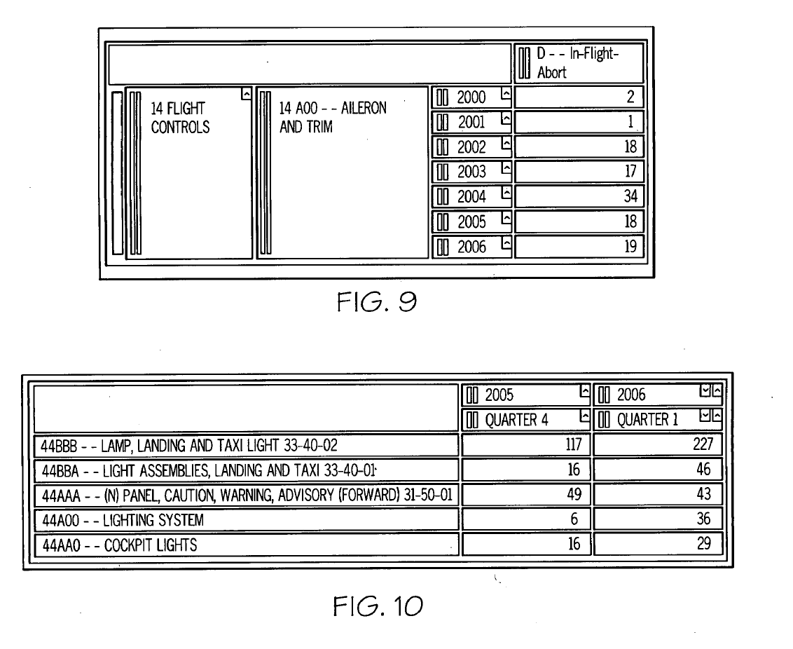

The third analysis looked at the Aileron and Trim in the data having no in-flight aborts, with the results shown by FIG. 9. It is to be appreciated that the data listed for 2006 is only for the first quarter in this example. Accordingly, the initial indication is a dramatic increase in flight control difficulties in only three months as compared to previous year totals. A drilldown into associated maintenance activities shows fourteen of nineteen maintenance actions are associated with routine post-maintenance inspection. As the drilldown quickly showed that maintenance personnel misidentified the Work Unit Code (WUC) for the maintenance, rapid access to the information provided in the underlying source records (e.g., FIG. 4) quickly resolves any concern about a potential flight control issue.

The fourth analysis looked at all Landing and Taxi Lights, wherein the results are shown by FIG. 10. It is be appreciated that in the results the information is broken down by quarter rather than by year. While not an expensive component, the activity represents a dramatic increase in utilization of maintenance man-hours. This presents managers with an opportunity to consider merits of a particular component and explore alternative components whose cost and increase in time between replacement can be correlated to save program dollars.

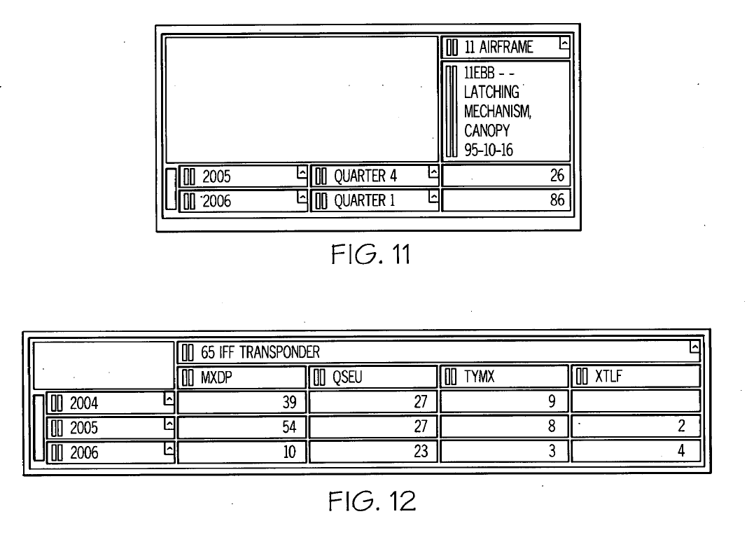

The fifth analysis looked at all Canopy Latching Mechanism, in which the results are shown by FIG. 11. It can be observed from the results that the visits to the aircraft for this issue increased by a factor of 3.3 between fourth quarter 2005 and first quarter 2006. Parts cost may not be a significant factor, but again the cost of maintenance man-hours may drive acquisition and logistics personnel to explore changes to reduce maintenance cost. More than one visit per flying day fleet-wide average to perform this maintenance on a relatively new pressurized aircraft should be an attention-getter. Such an issue could be identified in the future as the weak link in a safety chain leading up to an accident.

The sixth analysis looked at all IFF Mode S Transponder, in which the results are shown by FIG. 12. The removal rate for this item can be determined from the next level of drilldown. The removal rate for first quarter 2006 at Moody AFB was 12 units. This rate of failure falls into the frequency category of “Probable,” significantly greater than 10 per 100,000 platform operating hours. The cost of this item exceeds $12,000 per unit. The monetary loss results in a criticality rating of “Marginal.” This results in a Probable/Marginal MRA value of “9” in the USAF and “IIIB” in the USN. In both cases, the failure rate is listed as undesirable. The USAF MRA value requires Program Executive Officer approval for risk acceptance.

The value of the analysis revealing the issues noted above is difficult to overstate. These issues had not previously received adequate attention because they were not reported as significant problems by operators, maintainers, or the OEM. Analysis of only previously identified problem areas is inadequate. Ongoing full-system analysis is critical for operational safety, proper system health monitoring, cost avoidance, cost saving, and responsible program oversight.

### USAF/USN-Requested Landing Gear System Analysis

USAF data provided comprised of: 330,000+ total maintenance activities representing, 650,000+ maintenance man-hour records, 56,024 Landing Gear System (LGS) maintenance records, and 94,126 LGS maintenance man-hour records. The LMO system 10 searched the full database to retrieve LGS mismatches (data that had been improperly coded by field maintenance personnel and thus lost to analysis). The LMO system 10 discovered over 1,000 mismatches, representing a 2% loss of pertinent data. Among the mismatches, LMO system 10 discovered over 100 jewels (lost records that had significant analysis value relating to major system malfunctions and/or failures). The Nose Landing Gear (NLG) Spring Strut Cartridge, responsible for a 2005 gear-up landing, exhibited an undetected failure rate of 18.5 per 100,000 flight hours during 2001. The MRA for this failure rate is Probable/Critical, with a USAF MRA value of 5 (HIGH) and a USN value of IIB (HIGH/UNACCEPTABLE). This failure rate is regarded as undetected because it raised no alarms in 2001 and was not addressed as a maintenance issue at the time. The NLG Spring Strut Cartridge had three failures that were discovered as mismatches during analysis. These mismatches were also categorized as jewels. In 2004, a broken cartridge was replaced, creating a failure rate of 1.4 per 100,000 flight hours and an MRA of Occasional/Critical, translating to a USAF 6 (SERIOUS) and a USN IIC (MEDIUM/UNDESIRABLE). In 2005, just months before the gear-up landing, 1) an improper cotter key was discovered and replaced and 2) a bad cotter key was discovered and replaced. None of these actions were properly associated with the spring strut cartridge in the maintenance database.

A review of all LGS maintenance actions indicated that parts were replaced 42% of the time (23,390 of 56,024 activities). Sixty-nine percent (69%) of these replacement actions (16,050 of 23,390) were not identified by specific Work Unit Code (WUC). Improperly assigned WUCs were either system or sub-system generic, assigned codes identified as “not otherwise coded,” or they were simply incorrect. Multiple instances were discovered where maintenance was recorded under WUCs that did not exist. Analysis confirmed previously identified problem areas involving the LGS. Analysis was used to show trends associated with system redesigns and various other issue mitigating activities. Improving, negligible, and worsening trends were displayed in a manner that simplified data review and interpretation.

### Additional US Navy (USN) Data Analysis

Subsequent to the receipt of USAF JPATS data, the inventors also received 11.5 months of USN maintenance data (OOMA). This data was analyzed to demonstrate some additional LMO capabilities that may be of assistance to contracting personnel as well as program leadership. The following warranty-related information was analyzed from the USN data: USN maintenance data covered 1 Sep. 2004 through 12 Aug. 2005, and 19,924.5 flight hours conducted during the data period. The results showed the following information for the below noted eight parts:

1. VHF Navigation Radio—warranted for 24 months/2,000 flight hours:
a. Four removals during the data period
b. Two of four units (50%) under warranty when removed
c. One unit less than three months beyond warranty expiration
d. At more than $8,000 per unit, total value of warranted parts removed exceeds $16,000.
   2. DME Receiver—warranted for 24 months/2,000 flight hours:
a. Two removals during the data period
b. Both units (100%) under warranty when removed
c. At more than $9,000 per unit, total value of warranted parts removed exceeds $18,000.
   3. Mode S Transponder—warranted for 24 months/2,000 flight hours:
a. Ten removals during the data period
b. Seven of ten units (70%) under warranty when removed
c. One unit less than three months beyond warranty expiration
d. At more than $12,000 per unit, total value of warranted parts removed exceeds $84,000.
   4. UHF Transceiver—warranted for 24 months/2,000 flight hours:
a. Sixteen removals during the data period
b. Eleven of sixteen units (69%) under warranty when removed
c. Two units less than three months beyond warranty expiration
d. At more than $13,000 per unit, total value of warranted parts removed exceeds $143,000.
   5. Engine Data Manager (EDM)—warranted for 2,000 flight hours from DD250:
a. Six removals during the data period
b. All units (100%) under warranty when removed
c. At more than $30,000 per unit, total value of warranted parts removed exceeds $180,000.
   6. Data Adapter—warranted for 24 months/2,000 flight hours:
a. Forty removals during the data period
b. Thirty-five of forty units (88%) under warranty when removed
c. Three units less than three months beyond warranty expiration
d. At more than $6,000 per unit, total value of warranted parts removed exceeds $210,000.
   7. Radio Management Unit (RMU)—warranted for 24 months/2,000 flight hours:
a. Thirty-nine removals during the data period
b. Thirty-six of thirty-nine units (92%) under warranty when removed
c. Two units were than three months beyond warranty expiration
d. At more than $6,000 per unit, total value of warranted parts removed exceeds $216,000.
   8. 5ATI Electronic Attitude Direction Indicator/Electronic Horizontal Situation Indicator display (EADI/EHSI)—warranted for 24 months/2,000 flight hours:
a. Seventy-six removals during the data period
b. Sixty-eight of seventy-six units (90%) under warranty when removed
c. Four units less than three months beyond warranty expiration

At more than $40,000 per unit, total value of the above noted warranted parts removed during the data period was over $2,720,000. The parts presented are only eight of one hundred twenty-two warranted parts (7%) on the T-6A aircraft. These parts represent over $3.587 million in warranted hardware removed from aircraft during the data period. With less than 20,000 operational hours during the data period, the monetary amount associated with these eight parts was more than $179.00 per flight hour. Due to limitations with the type and amount data provided, the inventors were unable to determine if the CLS provider properly discounted the Cost Per Flying Hour (CPFH) based on warranty returns. Industry data from warranty-intensive sectors (the US auto industry in particular) indicates a less than 10% recovery rate for eligible warranted items (claims are simply not filed in most cases). Considering that warranty recovery activity has not been a high priority in Government operations, it is plausible that the T-6A CPFH does not accurately reflect reduced pricing due to warranty recovery.

Considering that USAF/USN T-6A fleet operations will approach 400,000 flight hours per year by 2013-2014, $179.00 per flight hour translates into $71.6 million per year. This substantial amount of money, based on only 7% of the warranted parts of a single military aircraft, barely scratches the surface of the potential savings that LMO analysis can provide for the Government.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims.

1. A computer-readable medium, tangibly embodied, including a logistics, maintenance, and operations data visualization (LMO) tool, the computer-readable medium comprising instructions for:
receiving maintenance and repair data from multiple sources;
using maintenance codes and their respective narrative descriptions, part numbers, and other maintenance coding information provided in the maintenance and repair data as a basis for finding inaccuracies and inconsistencies in the received maintenance and repair data;
correcting found inaccuracies and inconsistencies in the received maintenance and repair data to provide refined data;
performing multiple analysis functions of the refined data to determine at least a base statistics and a reliability forecast for each component provided in the received maintenance and repair data;
generating a report for viewing each component and the associated base statistics and reliability forecast; and
displaying the report on an output device.

2. The computer-readable medium of claim 1, wherein the received maintenance and repair data includes component types categorizing parts for a specific platform.

3. The computer-readable medium of claim 1, wherein the base statistics provided in the generated report includes information relating to part information and activity information.

4. The computer-readable medium of claim 1, wherein the reliability forecast provided in the generated report includes information relating to part information and desired target reliability rate fields.

5. The computer-readable medium of claim 3, wherein the part information includes at least one of a part maintenance code, a part category, a part name, and a maintenance manual reference, and the activity information includes at least one of maintenance actions, unscheduled maintenance actions, parts removed, average maintenance hours, maintenance hours, parts under warranty, and percentage of parts under warranty.

6. The computer-readable medium of claim 1, wherein the part information includes at least one of a part maintenance code, a part category, a part name, a maintenance manual reference, and a part unit cost, and the desired target reliability rate fields correlates operating limits with each level of desired reliability, along with the number of such parts needed on hand in supply per year and the associated cost in order to meet each level of desired reliability for a given operating limits.

7. The computer-readable medium of claim 1, further including instructions for enabling a user to populate the reliability forecast with customized data.

8. The computer-readable medium of claim 2, wherein the specific platform include at least one of an airplane, a weapon system, and military hardware.

9. The computer-readable medium of claim 1, further including instructions for sending notification to responsible ones of the multiple sources when a component in the report is indicated as removed and under warranty for replacement.

10. The computer-readable medium of claim 1, further including instructions for enabling a user to select in the report a rank view, selected maintenance code view, and a source records view.

11. A method for providing a logistics, maintenance, and operations data visualization (LMO) tool, to a user, comprising:
receiving maintenance and repair data from multiple sources on a platform;
using maintenance codes and their respective narrative descriptions, part numbers, and other maintenance coding information provided in the maintenance and repair data as a basis for finding inaccuracies and inconsistencies in the received maintenance and repair data;
correcting found inaccuracies and inconsistencies in the received maintenance and repair data to provide refined data;
performing multiple analysis functions of the refined data to determine at least a base statistics and a reliability forecast for each component provided in the received maintenance and repair data;
generating a report for viewing each component and the associated base statistics and reliability forecast; and
displaying the report on an output device of the platform.

12. A computer system, comprising: an output device; an input device; a central processing unit in communication with the input device and output device; and the computer readable medium as in claim 1, wherein the central processing unit executes the instructions to provide the LMO tool.
